(19) United States
(12) Patent Application Publication
(10) Pub. No.: US 2025/0269939 A1
(43) Pub. Date: Aug. 28, 2025

(54) UNDERWATER ROBOT POSITIONING METHOD, UNDERWATER POSITIONING SYSTEM, AND READABLE STORAGE MEDIUM

(71) Applicant: Shenzhen Seauto Technology Co., Ltd., Shenzhen (CN)

(72) Inventor: Hansheng Mo, Shenzhen (CN)

(21) Appl. No.: 19/024,079

(22) Filed: Jan. 16, 2025

Related U.S. Application Data
(63) Continuation-in-part of application No. PCT/CN2023/083836, filed on Mar. 24, 2023.

(30) Foreign Application Priority Data
Feb. 23, 2023 (CN) 202310194116.2

(51) Int. Cl. B63B 35/00; G01S 5/26

(52) U.S. Cl. CPC B63B 35/00; G01S 5/26; B63B 2035/007

(57) ABSTRACT

The present application relates to the technical field of underwater robot sensing, and in particular, to an underwater robot positioning method, an underwater positioning system, and a readable storage medium. The method includes: when a positioning request sent by a positioning base station is received, acquiring a positioning request receiving moment for receiving the positioning request, and sending a positioning response to the positioning base station; receiving a positioning response receiving moment sent by the positioning base station; according to the positioning request receiving moment and the positioning response receiving moment, determining spacing distances of an underwater robot with respect to a hydrophone and an underwater acoustic communication module; and, according to the spacing distances and position information of the positioning base station, updating positioning information of the underwater robot.

### CROSS-REFERENCE TO RELATED APPLICATIONS

This application is a Bypass Continuation application of PCT International Application No. PCT/CN2023/083836 filed on Mar. 24, 2023, which claims the priority of Chinese Application No. 202310194116.2, filed on Feb. 23, 2023, the disclosures of which are incorporated in their entirety by reference herein.

### TECHNICAL FIELD

The present application relates to the technical field of underwater robot sensing, and in particular, to an underwater robot positioning method, an underwater positioning system, and a readable storage medium.

### BACKGROUND

According to the related prior art of underwater robot detection, underwater mapping is usually performed by controlling underwater robots to move underwater and continuously scan the surrounding environment. When the mapping is completed, the robots then performs coordinate positioning based on the constructed underwater mapping.

However, the above described method relies on underwater mapping for coordinate positioning: the current underwater mapping requires robots to travel through each point on an underwater ground once or several times, and more accurate mapping can be performed only after obtaining sufficient data. Such processes are time consuming. When a to-be-detected underwater area is large, cost of underwater detection increases significantly. In addition, when underwater robots are disturbed by environmental factors such as different terrain and water flows of the underwater area during the mapping process, the accuracy of mapping is reduced, resulting in inaccurate positioning of the underwater robot in the subsequent positioning process.

The above contents are only used to assist in understanding the technical solution of the present application and do not constitute an admission that the above contents are prior art.

### SUMMARY

The present application provides an underwater robot positioning method to position the underwater robots independent of underwater mapping.

The present application provides an underwater robot positioning method. The method includes:
when a positioning request sent by a positioning base station is received, acquiring a first time stamp when the positioning request is received, and sending a positioning response, in response to the positioning request, to the positioning base station;
receiving at least one second time stamp when the positioning response is received by the positioning base station, wherein the at least one second time stamp includes a third time stamp when at least one hydrophone receives the positioning response and a fourth time stamp when an underwater acoustic communication module receives the positioning response;
determining spacing distances of the underwater robot with respect to the hydrophone and the underwater acoustic communication module according to the first time stamp and the second time stamp, wherein the spacing distances include a first spacing distance which is a distance between the underwater robot to the underwater acoustic communication module and a second spacing distance which is a distance between the underwater robot to the hydrophone; and
updating positioning information of the underwater robot according to the spacing distances and position information of the positioning base station.

Optionally, before determining spacing distances of the underwater robot with respect to the hydrophone and the underwater acoustic communication module according to the first time stamp and the second time stamp, the method further includes:
acquiring a preset underwater acoustic wave signal propagation speed and a preset redundant time duration;
determining spacing distances of the underwater robot with respect to the hydrophone and the underwater acoustic communication module according to the first time stamp and the second time stamp includes:
determining a time difference between the first time stamp and the second time stamp, wherein the time difference includes a first time difference from the positioning response to the underwater acoustic communication module and a second time difference from the positioning response to the hydrophone; and
calculating the spacing distances according to the underwater acoustic wave signal propagation speed, the redundant time duration and the time difference.

Optionally, calculating the spacing distances according to the underwater acoustic wave signal propagation speed, the redundant time duration and the time difference includes:
performing difference operation on the first time difference and the redundant time duration, determining a first signal propagation duration between the underwater acoustic communication module and the underwater robot, performing product operation on the first signal propagation duration and the underwater acoustic wave signal propagation speed, determining a first signal propagation distance value, and taking half of the first signal propagation distance value as a first spacing distance of the spacing distances; and
performing difference operation on the second time difference and the redundant time duration, determining a second signal propagation duration between the hydrophone and the underwater robot, performing product operation on the second signal propagation duration and the underwater acoustic wave signal propagation speed, determining a second signal propagation distance value, and taking half of the signal propagation distance value as a second spacing distance of the spacing distances.

Optionally, the hydrophone includes a first hydrophone and a second hydrophone, and before updating positioning information of the underwater robot according to the spacing distances and position information of the positioning base station, the method further includes:
constructing a first circle with the first spacing distance as a radius and a position of the underwater acoustic communication module as a circle center,
constructing a second circle with the second spacing distance as a radius and a position of the first hydrophone as a circle center, and/or constructing a third circle with a third spacing distance which is a distance from the underwater robot to the second hydrophone as a radius and a position of the second hydrophone as a circle center; and
determining the position information of the positioning base station according to coordinates of an intersection point among the first circle, the second circle and/or the third circle.

Optionally, determining the position information of the positioning base station according to coordinates of intersection points among the first circle, the second circle and/or the third circle includes:
determining the position information of the positioning base station according to coordinates of intersection points of two of the first circle, the second circle and/or the third circle;
or determining the position information of the positioning base station according to coordinates of intersection points of three of the first circle, the second circle and the third circle.

Optionally, determining the position information of the positioning base station according to coordinates of intersection points of two of the first circle, the second circle and/or the third circle includes:
when there is more than one coordinate of the intersection points of the two circles, acquiring historical positioning coordinates of the underwater robot determined in a previous period; and
selecting target coordinates of an intersection point of two circles with a minimum coordinate offset with the historical positioning coordinates from coordinates of intersection points of two circles, and determining the position information of the positioning base station according to the target coordinates of the intersection point of two circles.

Optionally, before updating positioning information of the underwater robot according to the spacing distances and position information of the positioning base station, the method further includes:
acquiring a traveling speed and a traveling direction, and current positioning information of the underwater robot;
calculating expected positioning information of the underwater robot at a next time point according to the traveling speed and the traveling direction according to the current positioning information;
updating positioning information of the underwater robot according to the spacing distances and position information of the positioning base station includes:
determining sonar positioning information of the underwater robot according to the spacing distances and the position information;
determining an error value between the sonar positioning information and the expected positioning information;
when the error value is less than or equal to a preset error threshold, updating the positioning information according to the sonar positioning information; and
when the error value is greater than the error threshold, adjusting the sonar positioning information based on the error value, and updating the positioning information according to the updated sonar positioning information.

In addition, to achieve the above objective, the present application further provides an underwater robot positioning method. The underwater robot positioning method includes:
sending a positioning request to the underwater robot;
when a positioning response fed back by the underwater robot according to the positioning request is received, acquiring a positioning response receiving moment for receiving the positioning response, wherein the positioning response receiving moment includes a moment when at least one hydrophone receives the positioning response and a moment when an underwater acoustic communication module receives the positioning response; and
sending the positioning response receiving moment to the underwater robot.

In addition, to achieve the above objective, the present application further provides an underwater positioning system. The underwater positioning system includes: an underwater robot, a base station, a non-transitory memory storage, a processor, and an underwater robot positioning program stored on the non-transitory memory storage and operable on the processor, wherein when the underwater robot positioning program is executed by the processor, the underwater robot is caused to execute the underwater robot positioning method as described above.

In addition, to achieve the above objective, the present application further provides a computer-readable non-transitory storage medium on which an underwater robot positioning program is stored, wherein the underwater robot positioning program, when being executed by a processor, implements the underwater robot positioning method as described above.

### BRIEF DESCRIPTION OF DRAWINGS

FIG. 1 is a schematic diagram of an architecture of a hardware operating environment of an underwater positioning system according to an embodiment of the present application;

FIG. 2 is a schematic flowchart of a first embodiment of an underwater robot positioning method according to the present application;

FIG. 3 is a schematic flowchart of a second embodiment of an underwater robot positioning method according to the present application;

FIG. 4 is a schematic diagram of calculating position information between an underwater robot and a positioning base station based on three-circle positioning;

FIG. 5 is a schematic flowchart of a third embodiment of an underwater robot positioning method according to the present application;

FIG. 6 is a schematic diagram of coordinates of intersection points of two circles;

FIG. 7 is a schematic diagram of a selection of target coordinates of the intersection points of the two circles shown in FIG. 6;

FIG. 8 is a schematic flowchart of a fourth embodiment of an underwater robot positioning method according to the present application;

FIG. 9 is a schematic flowchart of a fifth embodiment of an underwater robot positioning method according to the present application; and

FIG. 10 is a schematic diagram of an installation position and a structure of an underwater positioning system according to one embodiment.

The realization of the objectives, the functional features, and the advantages of the present application will be further explained in conjunction with the embodiments and with reference to the drawings.

### DETAILED DESCRIPTION OF EMBODIMENTS

The underwater robot positioning method according to the present application can directly calculate positioning coordinate information of the robot in a coordinate system constructed with a base station as an origin, so that the underwater bottom surface does not need to be continuously occupied for mapping, and the early preparation work is reduced. In addition, this method relates to the underwater acoustic communication technology, and data interaction can be performed in addition to positioning, which facilitates timely correction of positioning and navigation information.

For a better understanding of the above technical solutions, the following describes exemplary embodiments of the present application in detail with reference to the accompanying drawings. Although exemplary embodiments of the present disclosure are shown in the accompanying drawings, it should be understood that the present disclosure can be implemented in various forms and should not be limited to the embodiments set forth herein. Rather, these embodiments are provided to enable a more thorough understanding of the present disclosure and to fully convey the scope of the present disclosure to those skilled in the art.

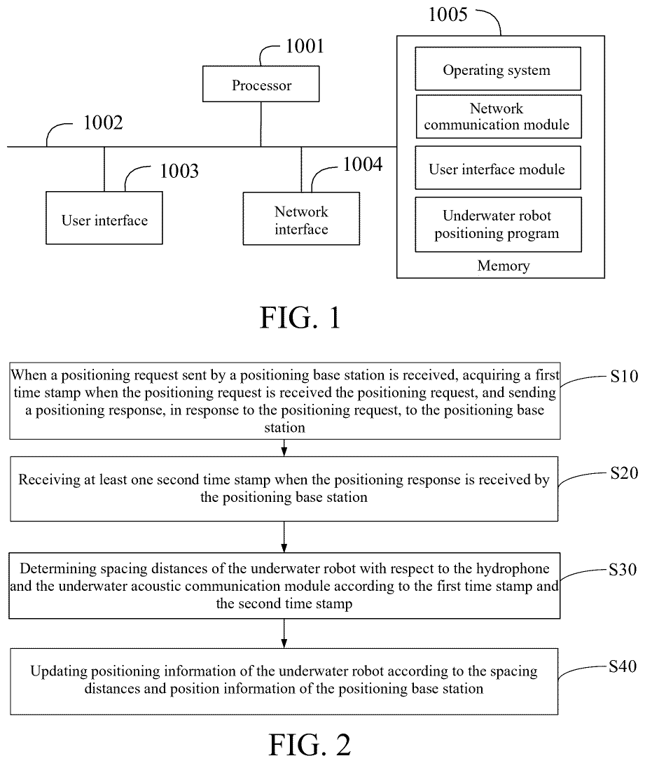

As an implementation solution, FIG. 1 is a schematic diagram of an architecture of a hardware operating environment of an underwater positioning system according to an embodiment of the present application.

As shown in FIG. 1, the underwater positioning system may include: a processor 1001 such as a CPU, a memory 1005, a user interface 1003, a network interface 1004, and a communication bus 1002. The communication bus 1002 is configured to implement connection and communication between these components. The user interface 1003 may include a display screen (display) and an input unit such as a keyboard. Optionally, the user interface 1003 may also include a standard wired interface and a wireless interface. The network interface 1004 may optionally include a standard wired interface, and a wireless interface (e.g., a WI-FI interface). The memory 1005 may be a high-speed RAM memory or a non-volatile memory such as a disk memory. Optionally, the memory 1005 may be a storage device separate from the processor 1001.

Those skilled in the art may understand that the architecture of the underwater positioning system shown in FIG. 1 does not constitute any limitation on the underwater positioning system. The underwater positioning system may include more or fewer components than those shown in the figure, or some components may be combined, or a different component deployment may be used.

As shown in FIG. 1, the memory 1005, as a storage medium, may include an operating system, a network communication module, a user interface module, and an underwater robot positioning program. The operating system is a program for managing and controlling hardware and software resources of the underwater positioning system, and an operation of an underwater robot positioning program, and other software or program.

In the underwater positioning system shown in FIG. 1, the user interface 1003 is mainly used to connect a terminal and communicate data with the terminal; the network interface 1004 is mainly used for a background server and is in data communication with the background server; and the processor 1001 may be used to call an underwater robot positioning program stored in the memory 1005.

In this embodiment, the underwater positioning system includes: a memory 1005, a processor 1001, and the underwater robot positioning program stored on the memory and operable on the processor.

When the processor 1001 calls the underwater robot positioning program stored in the memory 1005, the processor 1001 performs the following operations:
when a positioning request sent by a positioning base station is received, acquiring a a first time stamp when the positioning request is received, and sending a positioning response, in response to the positioning request, to the positioning base station;
receiving at least one second time stamp when the positioning response is received by the positioning base station, wherein the at least one second time stamp includes a third time stamp when at least one hydrophone receives the positioning response and a fourth time stamp when an underwater acoustic communication module receives the positioning response;
determining spacing distances of the underwater robot with respect to the hydrophone and the underwater acoustic communication module according to the first time stamp and the second time stamp, wherein the spacing distances include a first spacing distance which is a distance between the underwater robot to the underwater acoustic communication module and a second spacing distance which is a distance between the underwater robot to the hydrophone; and
updating positioning information of the underwater robot according to the spacing distances and position information of the positioning base station.

When calling the underwater robot positioning program stored in the memory 1005, the processor 1001 performs the following operations:
acquiring a preset underwater acoustic wave signal propagation speed and a preset redundant time duration;
determining spacing distances of the underwater robot with respect to the hydrophone and the underwater acoustic communication module according to the first time stamp and the second time stamp includes:
determining a time difference between the positioning request receiving moment and the positioning response receiving moment, wherein the time difference includes a first time difference from the positioning response to the underwater acoustic communication module and a second time difference from the positioning response to the hydrophone; and
calculating the spacing distances according to the underwater acoustic wave signal propagation speed, the redundant time duration and the time difference.

When calling the underwater robot positioning program stored in the memory 1005, the processor 1001 performs the following operations:
performing difference operation on the first time difference and the redundant time duration, determining a first signal propagation duration between the underwater acoustic communication module and the underwater robot, performing product operation on the first signal propagation duration and the underwater acoustic wave signal propagation speed, determining a first signal propagation distance value, and taking half of the first signal propagation distance value as a first spacing distance of the spacing distances; and
performing difference operation on the second time difference and the redundant time duration, determining a second signal propagation duration between the hydrophone and the underwater robot, performing product operation on the second signal propagation duration and the underwater acoustic wave signal propagation speed, determining a second signal propagation distance value, and taking half of the signal propagation distance value as a second spacing distance of the spacing distances.

When calling the underwater robot positioning program stored in the memory 1005, the processor 1001 performs the following operations:
constructing a first circle with the first spacing distance as a radius and the position of the underwater acoustic communication module as a circle center,
constructing a second circle with the second spacing distance as a radius and the position of the first hydrophone as a circle center, and/or constructing a third circle with the third spacing distance from the underwater robot to the second hydrophone as a radius and the position of the second hydrophone as a circle center; and
determining the position information of the positioning base station according to coordinates of an intersection point among the first circle, the second circle and/or the third circle.

When calling the underwater robot positioning program stored in the memory 1005, the processor 1001 performs the following operations:
determining the position information of the positioning base station according to coordinates of intersection points of two of the first circle, the second circle and/or the third circle;
or determining the position information of the positioning base station according to coordinates of intersection points of three of the first circle, the second circle and the third circle.

When calling the underwater robot positioning program stored in the memory 1005, the processor 1001 performs the following operations:
when there is more than one coordinate of the intersection points of the two circles, acquiring historical positioning coordinates of the underwater robot determined in a previous time period; and
selecting target coordinates of an intersection point of two circles which have a minimum coordinate offsets from the historical positioning coordinates from coordinates of intersection points of two circles, and determining the position information of the positioning base station according to the target coordinates of the intersection point of two circles.

When calling the underwater robot positioning program stored in the memory 1005, the processor 1001 performs the following operations:
acquiring a traveling speed and a traveling direction as well as current positioning information of the underwater robot;
calculating expected positioning information of the underwater robot at a next time point according to the traveling speed and the traveling direction according to the current positioning information;
determining sonar positioning information of the underwater robot according to the spacing distances and the position information;
determining an error value between the sonar positioning information and the expected positioning information;
when the error value is less than or equal to a preset error threshold, updating the positioning information according to the sonar positioning information; and
when the error value is greater than the error threshold, adjusting the sonar positioning information based on the error value, and updating the positioning information according to the updated sonar positioning information.

When calling the underwater robot positioning program stored in the memory 1005, the processor 1001 performs the following operations:
sending a positioning request to an underwater robot;
when a positioning response fed back by the underwater robot according to the positioning request is received, acquiring a positioning response receiving moment for receiving the positioning response, wherein the positioning response receiving moment includes a moment when at least one hydrophone receives the positioning response and a moment when an underwater acoustic communication module receives the positioning response; and
sending the positioning response receiving moment to the underwater robot.

Based on the hardware architecture of the underwater positioning system based on the underwater robot sensing technology, an embodiment of the underwater robot positioning method according to the present application is provided.

Referring to FIG. 2, in a first embodiment, the underwater robot positioning method includes the following steps:

Step S10: when a positioning request sent by a positioning base station is received, acquiring a positioning request receiving moment for receiving the positioning request, and sending a positioning response to the positioning base station.

Step S20: receiving a positioning response receiving moment sent by the positioning base station.

In this embodiment, the underwater positioning system is composed of an underwater robot and a positioning base station, the positioning base station sends a positioning request to the underwater robot, and the underwater robot processes the positioning request and feeds a positioning response back to the positioning base station.

Specifically, when receiving the positioning request, the underwater robot records a timestamp of a moment when receiving the positioning request as a positioning request receiving moment T1, and feeds back a positioning response to the positioning base station, wherein when receiving the positioning response, the positioning base station also records a timestamp of a moment when receiving the positioning response as a positioning response receiving moment T2.

Optionally, the signal type of the positioning request and positioning response can be sonar signals. Sonar signals are configured for underwater communication, and the propagation and reflection characteristics of acoustic waves in water are used to perform navigation and ranging through electro-acoustic conversion and information processing.

Optionally, to prevent the underwater robot from being disturbed during underwater operations, when receiving a signal request, the underwater robot first parses this signal request, and determines that this signal is a signal of the positioning request but not other communication signals after determining that an identifier of a sending end of this request is a legal identifier.

Optionally, the positioning base station sends a positioning request to the underwater robot at a preset period, so that the underwater robot can correspondingly update the positioning information of the underwater robot according to the positioning requests of different periods, and thus, the underwater monitoring staff can acquire the position of the underwater robot in real time.

In this embodiment, the positioning base station is provided with an underwater acoustic communication module and at least one hydrophone, wherein the underwater acoustic communication module sends out a modulated communication signal, and receives, demodulates and processes a signal from the water robot. In addition, the hydrophone can also receive a signal from the water robot, and the water robot is also provided with an underwater acoustic communication module, which has the same function as the underwater acoustic communication module on the positioning base station.

Further, both the underwater acoustic communication module and the hydrophone in the positioning base station can receive a positioning response, and the positioning base station can record a positioning response receiving moment by the underwater acoustic communication module and/or the hydrophone. The moment when the positioning response is received by the underwater acoustic communication module is T21, and the moment when the positioning response is received by the hydrophone is T22. Then the positioning base station sends a positioning response moment T2 including T21 and T22 to the underwater robot.

Step S30: determining spacing distances of the underwater robot with respect to the hydrophone and the underwater acoustic communication module according to the positioning request receiving moment and the positioning response receiving moment.

In this embodiment, after receiving the positioning response moment T2, the robot determines the spacing distances of the underwater robot with respect to the hydrophone and the underwater acoustic communication module according to the positioning request receiving moment T1 and the positioning response moment T2, wherein the spacing distances include a first spacing distance of the underwater robot with respect to the underwater acoustic communication module and a second spacing distance of the underwater robot with respect to the hydrophone.

Optionally, the spacing distances may be determined by underwater ranging. Specifically, an underwater acoustic wave signal propagation speed v and a preset redundant time duration Td are prestored in the underwater robot, wherein the redundant time duration Td is represented as a minimum fixed duration required by the underwater robot for processing a positioning request signal and sending a positioning request response. When the spacing distances need to be calculated, v and Td are acquired first, then the time difference between T2 and T1 is determined ΔT=T2−T1, and Td is subtracted from ΔT, so that the round-trip propagation time of the acoustic wave signal between the underwater robot and the positioning base station can be obtained as T=ΔT−Td. A duration of the round-trip propagation between the underwater robot and the underwater acoustic communication module is taken as a first signal propagation duration T₁, and a duration of the round-trip propagation between the underwater robot and the hydrophone is taken as a second signal propagation duration T₂.

Next, the first signal propagation duration T₁ and the underwater acoustic wave signal propagation speed v are multiplied and halved, so that the first spacing distance between the underwater robot and the underwater acoustic communication module can be obtained as S₁=T₁*v/2. Similarly, the second signal propagation duration T₂ and the underwater acoustic wave signal propagation speed v are multiplied and halved, so that the second spacing distance between the underwater robot and the hydrophone can be obtained as S₂=T₂*V/2.

Step S40: updating positioning information of the underwater robot according to the spacing distances and position information of the positioning base station.

In this embodiment, after the spacing distances are determined, the underwater robot updates its positioning information according to the spacing distances and the position information of the underwater robot with respect to the positioning base station.

It should be noted that the position information of the positioning base station is determined by at least two spacing distances. In this embodiment, the position information is determined by a first spacing distance S₁ between the underwater robot and the underwater acoustic communication module and a second spacing distance S₂ between the at least one underwater robot and the hydrophone.

According to the technical solution provided by this embodiment, the distance between the underwater robot and the positioning base station is calculated based on the positioning signals sent between the underwater robot and the positioning base station and the propagation time of the positioning signals received by the underwater robot and the positioning base station, so that the distance and the direction of the underwater robot are determined according to the spacing distance and the position information, thereby achieving the self-positioning of the robot. This omits the underwater scanning and mapping in the underwater operation process of the underwater robot, reduces the preliminary preparation work, and achieves the effect of reducing the difficulty in underwater operation of the robot. In addition, this method only requires at least one hydrophone and a pair of underwater acoustic communication modules to complete the construction, which has a simple installation structure and is easy to operate.

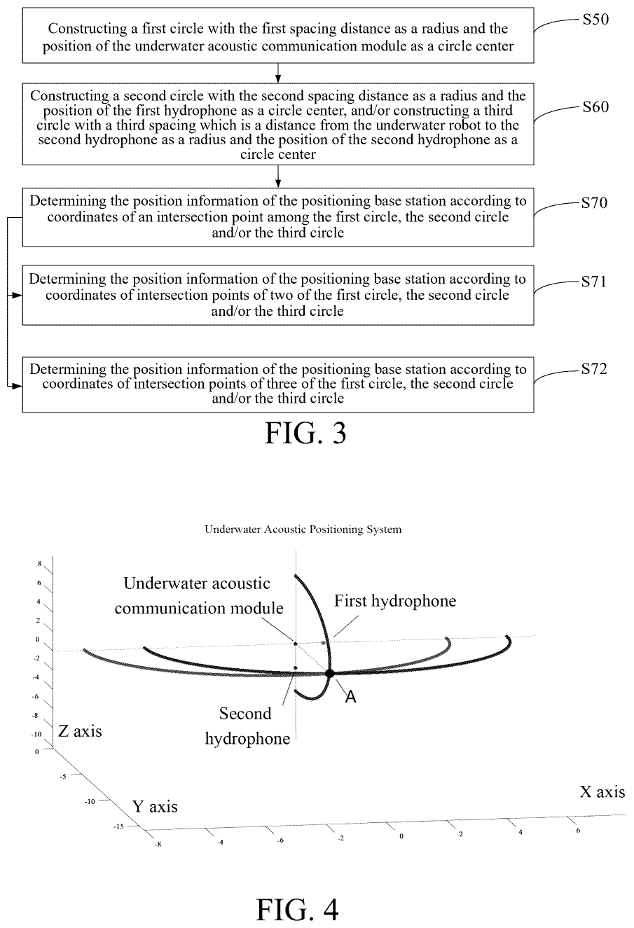

Referring to FIG. 3, in a second embodiment, based on the first embodiment, before the step S40, the method further includes:
step S50: constructing a first circle with the first spacing distance as a radius and the position of the underwater acoustic communication module as a circle center,
step S60: constructing a second circle with the second spacing distance as a radius and the position of the first hydrophone as a circle center, and/or constructing a third circle with the third spacing distance from the underwater robot to the second hydrophone as a radius and the position of the second hydrophone as a circle center; and
step S70: determining the position information of the positioning base station according to coordinates of an intersection point among the first circle, the second circle and/or the third circle.

Optionally, this embodiment provides a method for calculating the position information of a positioning base station according to the spacing distances. In this embodiment, the positioning base station also includes a hydrophone and an underwater acoustic communication module, wherein two hydrophones are provided, including a first hydrophone and a second hydrophone.

In this embodiment, a spacing distance between the underwater robot and the underwater acoustic communication module is a first spacing distance, a spacing distance between the underwater robot and the first hydrophone is a second spacing distance, and a spacing distance between the underwater robot and the second hydrophone is a third spacing distance.

A first circle is constructed with the first spacing distance as a radius and the position of the underwater acoustic communication module as a circle center, a second circle is constricted with the second spacing distance as a radius and the position of the first hydrophone as a circle center, and/or a third circle is constructed with the third spacing distance from the underwater robot to the second hydrophone as a radius and the position of the second hydrophone as a circle center. It should be noted that the positions of the underwater acoustic communication module, the first hydrophone and the second hydrophone are known, and alternatively, the positions may be coordinate points.

After the first circle, the second circle and/or the third circle are/is obtained, the position information of the positioning base station is determined according to the coordinates of the intersection points among the first circle, the second circle and/or the third circle.

The step S70 includes:
step S71: determining the position information of the positioning base station according to coordinates of intersection points of two of the first circle, the second circle and/or the third circle;
or step S72: determining the position information of the positioning base station according to coordinates of intersection points of three of the first circle, the second circle and the third circle.

In addition, it should be noted that there are at least two solutions:
firstly, the underwater robot positioning is performed according to an underwater acoustic communication module and two hydrophones; and
secondly, the underwater robot positioning is performed according to the underwater acoustic communication module and one of the two hydrophones.

Optionally, the difference between the two solutions is at least that: in the first solution, three-circle positioning is used, which has higher positioning accuracy but requires the installation of two hydrophones; in the second solution, two circles are configured for positioning, which has lower positioning cost and faster positioning speed but higher positioning cost.

According to the first solution, for example, referring to FIG. 4, FIG. 4 is a schematic diagram of calculating position information between an underwater robot and a positioning base station based on three-circle positioning, and three determined distances r0, r1, and r2 from the underwater robot to the underwater acoustic communication module, the first hydrophone, and the second hydrophone are substituted into a circle equation expression:

X=r*cos(θ)+x_{i=0,1,2}

Y=r*sin(θ)+y_{i=0,1,2}
wherein, (x₀,y₀) is the position coordinates (i.e., the origin) of the underwater acoustic communication module, (x₁,y₁) is the position coordinates of the first hydrophone, and (x₂,y₂) is the position coordinates of the second hydrophone, and the three coordinates are known quantities.

An intersection point A of a plurality of circles is obtained, and the coordinates of the intersection point A are the relative coordinates of the underwater robot with the underwater acoustic communication module as the origin. The intersection point A of the plurality of circles is substituted into the circle equation expression to reversely calculate the position information between the robot and the base station.

According to the second solution, the calculation process of the position information based on the two-circle positioning is similar to that described above, except that the circle equation with a spacing distance is reduced. Details are not described herein.

According to the technical solution provided by this embodiment, the position information of the underwater robot with respect to the positioning base station is determined through two-circle positioning or three-circle positioning and based on the spacing distances, which achieves the self-positioning of the robot, reduces the preliminary preparation work, and achieves the effect of reducing the difficulty in underwater operation of the robot.

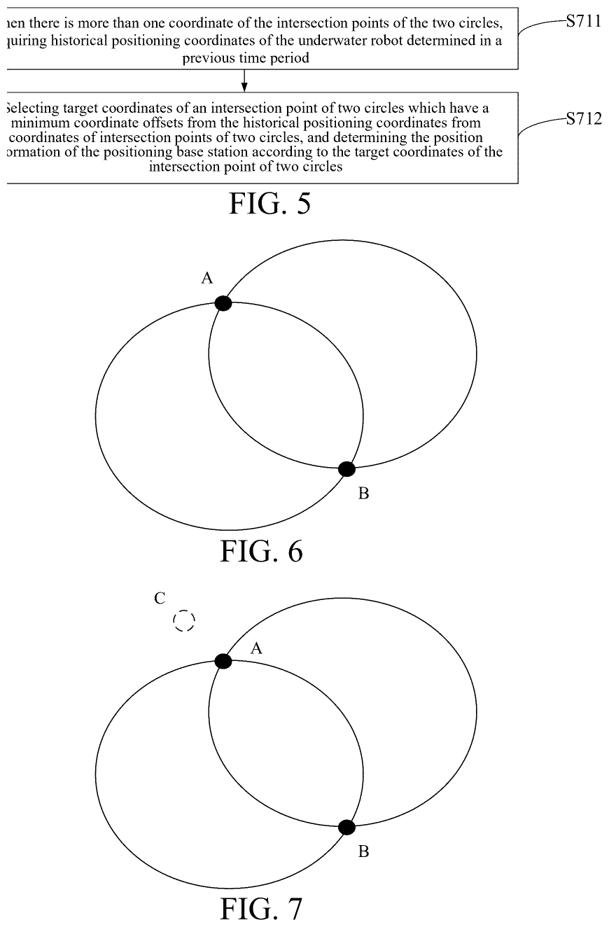

Referring to FIG. 5, in a third embodiment, based on any one of the embodiments, the step S71 includes:
step S711: when there is more than one coordinate of the intersection points of the two circles, acquiring historical positioning coordinates of the underwater robot determined in a previous period; and
step S712: selecting target coordinates of an intersection point of two circles with a minimum coordinate offset with the historical positioning coordinates from coordinates of intersection points of two circles, and determining the position information of the positioning base station according to the target coordinates of the intersection point of two circles.

Optionally, when the two-circle positioning is used to position the underwater robot, a situation may occur where there are two intersection points of the two circles, A and B, as shown in FIG. 6. In this case, it is necessary to determine which of the two intersection points is used as the target coordinates of two-circle intersection point of the position information of the underwater robot. In this embodiment, when there is more than one coordinate of the intersection points of the two circles, historical positioning coordinates of the underwater robot determined in a previous period are acquired, wherein the historical positioning coordinates are also coordinates of the intersection points of the two circles. Then coordinates of an intersection point of two circles with a minimum coordinate offset with the historical positioning coordinates from coordinates of intersection points of two circles are selected as target coordinates of the intersection point of two circles.

For example, referring to FIG. 7, FIG. 7 is a schematic diagram of the selection of target coordinates of an intersection point of two circles, wherein point C is historical positioning coordinates of the underwater robot determined in the previous period, and point A with a minimum coordinate offset with point C is selected as positioning coordinates of the underwater robot in a current period.

It should be noted that if there are two coordinates of the intersection points of the two circles of the underwater robot determined in the first working period after the underwater robot is powered on, the coordinates of the intersection points of the two circles in the same direction as the direction in which the positioning response signal is sent are determined as the target coordinates of the intersection point of the two circles.

The position information of the underwater robot with respect to the positioning base station is calculated based on the target coordinates of the intersection point of the two circles.

According to the technical solution provided by this embodiment, when there are more than two positioning coordinates in the underwater robot positioning by two-circle positioning, one positioning coordinate closest to the historical positioning coordinate in the previous period is selected as a target positioning coordinate, so that the position information of the underwater robot with respect to a positioning base station is calculated according to the target positioning coordinates, and the self-positioning of the underwater robot is achieved by combining the determined spacing distances in the foregoing embodiment. This omits the underwater scanning and mapping in the underwater operation process of the underwater robot, reduces the preliminary preparation work, and achieves the effect of reducing the difficulty in underwater operation of the robot.

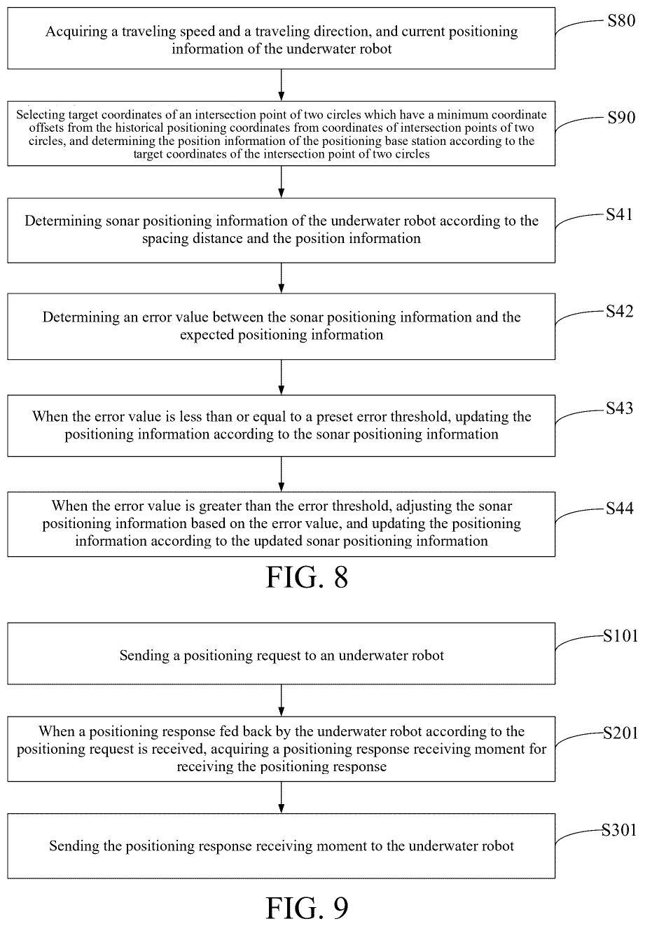

Referring to FIG. 8, in a fourth embodiment, based on any one of the embodiments, before the step S40, the method further includes:
step S80: acquiring a traveling speed and a traveling direction, and current positioning information of the underwater robot; and
step S90: predicting expected positioning information of the underwater robot at a next moment according to the traveling speed and the traveling direction based on the current positioning information.

Optionally, in this embodiment, since the positioning method adopted in the foregoing embodiment is sonar positioning, when there are other objects such as machinery and animals with acoustic wave emission capability in the underwater operation environment of the underwater robot, interference may be generated on sonar signals received by the positioning base station. Therefore, expected positioning information is introduced to correct the positioning information measured by the sonar in this embodiment.

Specifically, a travel speed and a travel direction of the robot during the operation process are first acquired, wherein the travel speed and the travel direction are both known quantities, and the travel speed is usually a preset value. The current positioning information of the robot is acquired. It should be noted here that since there is a certain hysteresis in updating the positioning information, the current positioning information is actually the positioning information of the robot determined in the previous period, and is not the positioning information of the current actual position of the robot during the operation process. Then, based on the current position information, the travel speed and the travel direction, and the time interval between two work periods, expected positioning information that the robot reaches in a next period can be calculated. Whether the sonar positioning information is correct or not is judged according to the expected positioning information.

The step S40 includes:
step S41: determining sonar positioning information of the underwater robot according to the spacing distances and the position information;
step S42: determining an error value between the sonar positioning information and the expected positioning information;
step S43: when the error value is less than or equal to a preset error threshold, updating the positioning information according to the sonar positioning information; and
step S44: when the error value is greater than the error threshold, correcting the sonar positioning information based on the error value, and updating the positioning information according to the corrected sonar positioning information.

Further, according to the spacing distances and the position information determined in the foregoing embodiments, sonar positioning information of the underwater robot including the distance and the range is determined. An error value between the sonar positioning information and the expected positioning information is then determined.

Optionally, the error value may be calculated by coordinates. For example, assuming that the sonar positioning coordinates S are (X₁,Y₁,Z₁) and the expected positioning coordinates E are (X₂,Y₂,Z₂), the calculation formula of the error value Z is:

$$Z = \sqrt{{( {X}_{2} - {X}_{1} )}^{2} + {( {Y}_{2} - {Y}_{1} )}^{2} + {( {Z}_{2} - {Z}_{1} )}^{2}}$$

Assume that the error threshold is Z₀, when Z≤Z₀, it is judged that the sonar positioning is accurate, and the positioning information is directly updated according to the sonar positioning information.

When Z>Z₀, it is judged that the sonar positioning result is inaccurate. After the sonar positioning information is corrected based on the error value Z, the positioning information is updated according to the corrected sonar positioning information.

Optionally, there are two methods to correct the sonar positioning information based on the error value Z:

Firstly, a coordinate correction value corresponding to the error value Z is matched in a preset positioning correction database.

For example, assume that the coordinate correction value to which the error value Z is matched is (X₀,Y₀,Z₀), the corrected sonar positioning coordinates S′ are (X₁+X₀, Y₁+Y₀, Z₁+Z₀).

Secondly, the adjustment ratio of each axis coordinate of the sonar positioning coordinate S is determined according to the error value Z.

For example, if an X-axis coordinate adjustment scaling factor of the error value Z is a, a Y-axis coordinate adjustment scaling factor is b, and a Z-axis coordinate adjustment scaling factor is c, the corrected sonar positioning coordinates S′ are:

$${S}^{′} = ( a {X}_{1} + b {Y}_{1} + c Z )$$

According to the technical solution provided by this embodiment, the expected positioning information is calculated through the traveling speed and the traveling direction of the robot, so that the correction of the sonar positioning information is achieved, and the positioning accuracy and the anti-interference capability of the underwater robot are improved.

In addition, referring to FIG. 9, in a fifth embodiment, the underwater robot positioning method further includes:
step S101: sending a positioning request to an underwater robot;
step S201: when a positioning response fed back by the underwater robot according to the positioning request is received, acquiring a positioning response receiving moment for receiving the positioning response; and
step S301: sending the positioning response receiving moment to the underwater robot.

In this embodiment, at the positioning base station end, the positioning base station is provided with an underwater acoustic communication module and at least one hydrophone, wherein the underwater acoustic communication module sends out a modulated communication signal, and receives, demodulates and processes a signal from the water robot. In addition, the hydrophone can also receive a signal from the water robot, and the water robot is also provided with an underwater acoustic communication module, which has the same function as the underwater acoustic communication module on the positioning base station.

Optionally, the positioning base station sends a positioning request to the underwater robot at a preset period, so that the underwater robot can correspondingly update the positioning information of the underwater robot according to the positioning requests of different periods, and thus, the underwater monitoring staff can acquire the position of the underwater robot in real time.

Further, both the underwater acoustic communication module and the hydrophone in the positioning base station can receive the positioning response, and the positioning base station can record a positioning response receiving moment by the underwater acoustic communication module and/or the hydrophone and send the positioning response receiving moment to the underwater robot.

In addition, it should be noted that, in some embodiments, for the positioning calculation of the underwater robot, the roles of the base station and the underwater robot may be interchanged, the robot sends a positioning request and processes a positioning request response sent by the base station, so as to complete the calculation of the distance and position information on the underwater robot.

According to the technical solution provided by this embodiment, the distance between the underwater robot and the positioning base station is calculated based on the positioning signals sent between the underwater robot and the positioning base station and the propagation time of the positioning signals received by the underwater robot and the positioning base station, so that the distance and the direction of the underwater robot are determined according to the spacing distance and the position information, thereby achieving the self-positioning of the robot. This omits the underwater scanning and mapping in the underwater operation process of the underwater robot, reduces the preliminary preparation work, and achieves the effect of reducing the difficulty in underwater operation of the robot. In addition, this method only requires at least one hydrophone and a pair of underwater acoustic communication modules to complete the construction, which has a simple installation structure and is easy to operate.

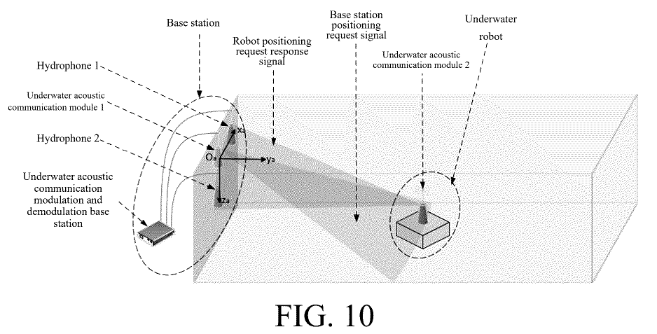

In addition, referring to FIG. 10, FIG. 10 is a schematic diagram of an installation position and a structure of an underwater positioning system according to one embodiment, wherein the underwater positioning system mainly includes a base station (i.e., a positioning base station) and an underwater robot. The base station includes an underwater acoustic communication modulation and demodulation base station, an underwater acoustic communication module 1, a hydrophone 1, and a hydrophone 2. The underwater acoustic communication module 1 is mainly configured for sending communication signals modulated by the underwater acoustic communication modulation and demodulation base station and receiving, demodulating and processing signals received by the underwater acoustic communication module 2 and the hydrophones.

The underwater robot is composed of an underwater robot main body and an underwater acoustic communication module 2, wherein the underwater robot main body provides a power supply, computing power and motion capability. The underwater acoustic communication module 2 provides the function of modulating and demodulating the underwater acoustic communication signal.

In addition, those of ordinary skill in the art can understand that all or part of the processes in the method of the above embodiment can be completed by instructing related hardware through a computer program. The computer program includes program instructions, and the computer program may be stored in a non-transitory storage medium that is a computer-readable non-transitory storage medium. The program instructions are executed by at least one processor in the underwater positioning system to implement the process steps of the embodiments of the above method.

Therefore, the present application further provides a computer-readable non-transitory storage medium on which an underwater robot positioning program is stored, wherein the underwater robot positioning program, when being executed by a processor, implements the steps of the underwater robot positioning method described in the above embodiments.

The computer-readable non-transitory storage medium may be a USB flash drive, a removable hard disk, a read-only memory (ROM), a magnetic disk, or an optical disk, and the like, which are computer-readable storage media that can store program codes.

It should be noted that, since the storage medium provided in the embodiment of the present application is the storage medium used to implement the method of the embodiment of the present application, based on the method introduced in the embodiment of the present application, those skilled in the art can understand the specific structure and deformation of the storage medium, and details are not described herein again. Any storage medium used in the method of the embodiment of the present application is within the protection scope of the present application.

It should be appreciated by those skilled in the art that embodiments of the present application may be provided as a method, a system, or a computer program product. Therefore, the present application may use a form of hardware only embodiments, software only embodiments, or embodiments with a combination of software and hardware. Furthermore, the present application may take the form of a computer program product implemented on one or more computer-usable storage media (including, but not limited to, disk memory, CD-ROM, optical memory, and the like) containing computer-usable program codes.

The present application is described with reference to flowcharts and/or block diagrams of a method, a device (system), and a computer program product according to the present application. It should be understood that each procedure and/or block of the flowcharts and/or block diagrams, and a combination of procedures and/or blocks in the flowcharts and/or block diagrams, can be implemented by computer program instructions. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may alternatively be stored in a computer-readable non-transitory storage medium that can instruct a computer or any other programmable data processing device to work in a specific manner, so that the instructions stored in the computer-readable non-transitory storage medium generate an artifact that includes an instruction apparatus. The instruction apparatus implements a specific function in one or more processes in the flowcharts and/or in one or more blocks in the block diagrams.

These computer program instructions may alternatively be loaded onto the computer or another programmable data processing device, so that a series of operations and steps are performed on the computer or another programmable device, to generate computer-implemented processing. Therefore, the instructions executed on the computer or another programmable device provide steps for implementing a specific function in one or more processes in the flowcharts and/or in one or more blocks in the block diagrams.

It should be noted that, in the claims, any reference signs placed between parentheses shall not be constructed as limiting the claim. The word “comprise” does not exclude the presence of elements or steps not listed in the claim. The word “a” or “an” preceding an element does not exclude the presence of a plurality of such elements. The present application can be implemented by means of hardware including several distinct elements, and by means of a suitably programmed computer. In a unit claim enumerating several means, several of these means may be embodied by the same item of hardware. The usage of the words such as “first”, “second” and “third” do not indicate any order. These words may be interpreted as names.

Although some preferred embodiments of the present application have been described, those skilled in the art can make changes and modifications to these embodiments after learning the basic inventive concept. Therefore, the appended claims are intended to be construed as including the preferred embodiments and all changes and modifications that fall within the scope of the present application.

It is clear that those skilled in the art can make various modifications and variations to the present application without departing from the spirit and scope of the present application. In this way, the present application is intended to cover these modifications and variations of the present application provided that these modifications and variations fall within the scope of protection defined by the following claims and their equivalent technologies.

1. An underwater robot positioning method, applied to an underwater robot, the method comprising:
when a positioning request sent by a positioning base station is received, acquiring a first time stamp when the positioning request is received, and sending a positioning response, in response to the positioning request, to the positioning base station;
receiving at least one second time stamp when the positioning response is received by the positioning base station, wherein the at least one second time stamp comprises a third time stamp when at least one hydrophone receives the positioning response and a fourth time stamp when an underwater acoustic communication module receives the positioning response;
determining spacing distances of the underwater robot with respect to the hydrophone and the underwater acoustic communication module according to the first time stamp and the second time stamp, wherein the spacing distances comprise a first spacing distance which is a distance between the underwater robot to the underwater acoustic communication module; and a second spacing distance which is a distance between the underwater robot to the hydrophone; and
updating positioning information of the underwater robot according to the spacing distances and position information of the positioning base station.

2. The method according to claim 1, before determining spacing distances of the underwater robot with respect to the hydrophone and the underwater acoustic communication module according to the first time stamp and the second time stamp, the method further comprising:
acquiring a preset underwater acoustic wave signal propagation speed and a preset redundant time duration; wherein
determining spacing distances of the underwater robot with respect to the hydrophone and the underwater acoustic communication module according to the first time stamp and the second time stamp comprises:
determining a time difference between the first time stamp and the second time stamp, wherein the time difference comprises a first time difference from the positioning response to the underwater acoustic communication module and a second time difference from the positioning response to the hydrophone; and
calculating the spacing distances according to the underwater acoustic wave signal propagation speed, the redundant time duration and the time difference.

3. The method according to claim 2, wherein calculating the spacing distances according to the underwater acoustic wave signal propagation speed, the redundant time duration and the time difference comprises:
performing difference operation on the first time difference and the redundant time duration, determining a first signal propagation duration between the underwater acoustic communication module and the underwater robot, performing product operation on the first signal propagation duration and the underwater acoustic wave signal propagation speed, determining a first signal propagation distance value, and taking half of the first signal propagation distance value as a first spacing distance of the spacing distances; and
performing difference operation on the second time difference and the redundant time duration, determining a second signal propagation duration between the hydrophone and the underwater robot, performing product operation on the second signal propagation duration and the underwater acoustic wave signal propagation speed, determining a second signal propagation distance value, and taking half of the signal propagation distance value as a second spacing distance of the spacing distances.

4. The method according to claim 1, wherein the hydrophone comprises a first hydrophone and a second hydrophone, and before updating positioning information of the underwater robot according to the spacing distances and position information of the positioning base station, the method further comprises:
constructing a first circle with the first spacing distance as a radius and a position of the underwater acoustic communication module as a circle center,
constructing a second circle with the second spacing distance as a radius and a position of the first hydrophone as a circle center, or constructing a third circle with a third spacing distance which is a distance from the underwater robot to the second hydrophone as a radius and a position of the second hydrophone as a circle center; and
determining the position information of the positioning base station according to coordinates of an intersection point between two circles of the first circle and the second circle or the third circle.

5. The method according to claim 4, wherein determining the position information of the positioning base station according to coordinates of intersection points of two circles of the first circle, the second circle or the third circle comprises:
when there is more than one coordinate of the intersection points of the two circles, acquiring historical positioning coordinates of the underwater robot determined in a previous time period; and
selecting target coordinates of an intersection point of two circles which have a minimum coordinate offsets from the historical positioning coordinates from coordinates of intersection points of two circles, and determining the position information of the positioning base station according to the target coordinates of the intersection point of two circles.

6. The method according to claim 1, wherein the hydrophone comprises a first hydrophone and a second hydrophone, and before updating positioning information of the underwater robot according to the spacing distances and position information of the positioning base station, the method further comprises:
constructing a first circle with the first spacing distance as a radius and a position of the underwater acoustic communication module as a circle center,
constructing a second circle with the second spacing distance as a radius and a position of the first hydrophone as a circle center, and constructing a third circle with a third spacing which is a distance from the underwater robot to the second hydrophone as a radius and a position of the second hydrophone as a circle center; and
determining the position information of the positioning base station according to coordinates of intersection points among three circles of the first circle, the second circle and the third circle.

7. The method according to claim 1, before updating positioning information of the underwater robot according to the spacing distances and position information of the positioning base station, the method further comprising:
acquiring a traveling speed and a traveling direction, and current positioning information of the underwater robot;
calculating expected positioning information of the underwater robot at a next time point according to the traveling speed and the traveling direction according to the current positioning information, wherein:
updating positioning information of the underwater robot according to the spacing distances and position information of the positioning base station comprises:
determining sonar positioning information of the underwater robot according to the spacing distances and the position information;
determining an error value between the sonar positioning information and the expected positioning information;
when the error value is less than or equal to a preset error threshold, updating the positioning information according to the sonar positioning information; and
when the error value is greater than the error threshold, adjusting the sonar positioning information based on the error value, and updating the positioning information according to the updated sonar positioning information.

8. An underwater robot positioning method, applied to a positioning base station, the positioning base station comprising an underwater acoustic communication module and a hydrophone, the underwater acoustic communication module and the hydrophone being used to establish a communication session with an underwater robot, the method comprising:
sending a positioning request to the underwater robot;
when a positioning response fed back by the underwater robot according to the positioning request is received, acquiring a positioning response receiving moment for receiving the positioning response, wherein the positioning response receiving moment comprises a moment when at least one hydrophone receives the positioning response and a moment when an underwater acoustic communication module receives the positioning response; and
sending the positioning response receiving moment to the underwater robot.

9. An underwater positioning system comprising: an underwater robot, a base station, a non-transitory memory storage, a processor and an underwater robot positioning program stored on the non-transitory memory storage and operable on the processor, wherein when the underwater robot positioning program is executed by the processor, the underwater robot is caused to execute the underwater robot positioning method according to claim 1.
